(19) United States
(12) Patent Application Publication
(10) Pub. No.: US 2026/0202614 A1
(43) Pub. Date: Jul. 16, 2026

(54) PHOTONIC INTEGRATED CIRCUIT AND METHODS OF FORMATION

(71) Applicant: Taiwan Semiconductor Manufacturing Company, Ltd., Hsinchu (TW)

(72) Inventors: Chi-Fan CHEN, Taoyuan City (TW); Wei-Cheng PAN, Taipei City (TW); Chih-Ming CHEN, Hsinchu City (TW); Chung-Yi YU, Hsin-Chu (TW); Tsung-Lin HSIEH, Hsinchu City (TW)

(21) Appl. No.: 19/018,171

(22) Filed: Jan. 13, 2025

(51) Int. Cl. G02B 6/136; G02B 6/12; G02B 6/122

(52) U.S. Cl. CPC G02B 6/136; G02B 6/1228; G02B 2006/12061; G02B 2006/12147; G02B 2006/12173

(57) ABSTRACT

A photonic integrated circuit of a semiconductor device includes a coupling waveguide that has a variable thickness between an edge coupler waveguide and a waveguide of another photonic component of the photonic integrated circuit. In particular, a thickness of the coupling waveguide at the first end of the coupling waveguide facing the edge coupler waveguide is less than a thickness of the coupling waveguide at a second end of the coupling waveguide facing the waveguide of the other photonic component. The thickness of the coupling waveguide may transition between the first end and the second end in an approximately linear manner (e.g., the coupling waveguide is tapered between the first end and the second end), in a curved manner (e.g., the coupling waveguide may have a non-linear transition between the first end and the second end), and/or in another manner.

### BACKGROUND

Photonic integrated circuits (PICs) can include multiple types of waveguides that are configured to perform different functions. Semiconductor waveguides (e.g., silicon (Si) waveguides) are often used in optical modulators because of the capability of modulating refractive indices in semiconductor waveguides by applying electric fields to the semiconductor materials of the semiconductor waveguides. Dielectric waveguides are often used for signal propagation and/or edge couplers because of the lower optical loss and higher thermal stability compared to the semiconductor materials of semiconductor waveguides.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C are diagrams of an example of a photonic integrated circuit described herein.

FIGS. 2A-2Z are diagrams of an example implementation of forming a photonic integrated circuit described herein.

FIGS. 3A and 3B are diagrams of an example implementation of a sloped section of a coupling waveguide described herein.

FIG. 4 is a flowchart of an example process associated with forming a photonic integrated circuit described herein.

FIG. 5 is a flowchart of an example process associated with forming a photonic integrated circuit described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A photonic integrated circuit of a semiconductor device may include a coupling waveguide that is configured to optically couple optical signals between an edge coupler waveguide and another photonic component that includes a waveguide, such as a polarizer, splitter, grating coupler, photodetector, and/or an optical modulator, among other examples.

In some cases, a waveguide may be manufactured to have a particular thickness so that a high optical performance can be achieved for the waveguide. For example, a coupling waveguide may be manufactured to have a thickness that is less than a thickness of another waveguide of another photonic component such as a polarizer or splitter. The lesser thickness of the coupling waveguide facilitates efficient coupling of optical signals between the coupling waveguide and an edge coupler waveguide with low transmission loss. However, if the difference in thickness between the coupling waveguide and the waveguide of the other photonic component becomes too large, optical coupling between the coupling waveguide and the waveguide of the other photonic component may be degraded, due to a high amount of reflection loss at the transition between the coupling waveguide and the waveguide of the other photonic component.

In some implementations described herein, a photonic integrated circuit of a semiconductor device includes a coupling waveguide that has a variable thickness between an edge coupler waveguide and a waveguide of another photonic component of the photonic integrated circuit. In particular, a thickness of the coupling waveguide at the first end of the coupling waveguide facing the edge coupler waveguide is less than a thickness of the coupling waveguide at a second end of the coupling waveguide facing the waveguide of the other photonic component. The thickness of the coupling waveguide may transition between the first end and the second end in an approximately linear manner (e.g., the coupling waveguide is tapered between the first end and the second end), in a curved manner (e.g., the coupling waveguide may have a non-linear transition between the first end and the second end), and/or in another manner.

The different thicknesses at the first end and the second end of the coupling waveguide enable a low transmission loss to be achieved for coupling of optical signals between the edge coupler waveguide and the coupling waveguide, and between the coupling waveguide and the waveguide of the other photonic component. The gradual transition between the different thicknesses enables a low reflection loss to be achieved between the coupling waveguide and the waveguide of the other photonic component relative to the transition between the thickness of the coupling waveguide and a thickness of the waveguide of the other photonic component being a stepped transition.

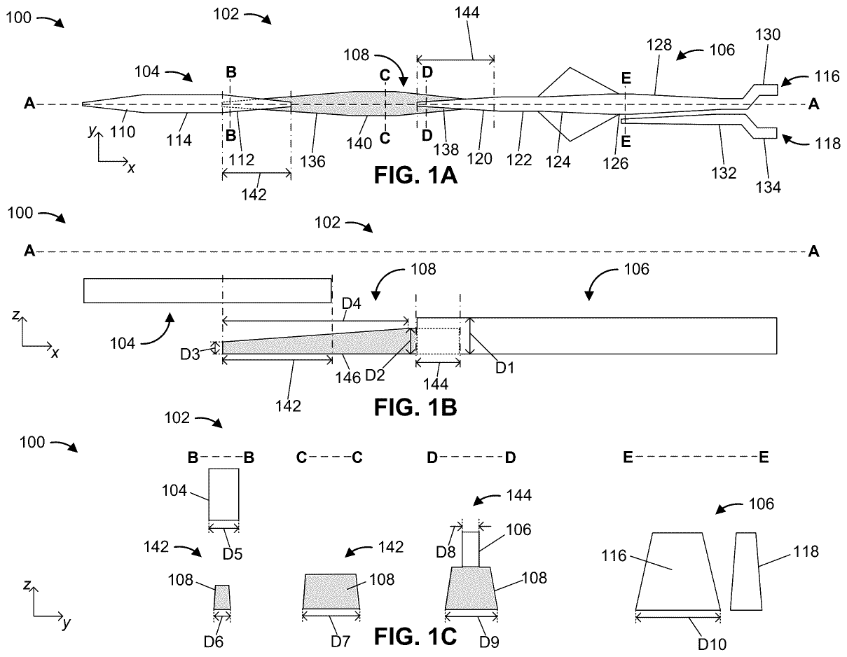

FIGS. 1A-1C are diagrams of an example 100 of a photonic integrated circuit 102 described herein. The photonic integrated circuit 102 may include an optical coupling circuit that includes an edge coupler waveguide 104, a waveguide 106, and a coupling waveguide 108 that optically couples the edge coupler waveguide 104 and the waveguide 106. In some implementations, the photonic integrated circuit 102 may be included in a semiconductor device, such as a semiconductor device 202 described herein.

FIG. 1A illustrates a top-down view of an x-y plane of the photonic integrated circuit 102. FIG. 1B illustrates a cross-sectional view of the photonic integrated circuit 102 along the line A-A in the x-direction in FIG. 1A. FIG. 1C illustrates a plurality of cross-section views in the y-direction in FIG. 1A, such as a cross-sectional view of the photonic integrated circuit 102 along the line B-B in FIG. 1A, a cross-sectional view of the photonic integrated circuit 102 along the line C-C in FIG. 1A, a cross-sectional view of the photonic integrated circuit 102 along the line D-D in FIG. 1A, and a cross-sectional view of the photonic integrated circuit 102 along the line E-E in FIG. 1A.

As shown in FIG. 1A, the edge coupler waveguide 104, the waveguide 106, and the coupling waveguide 108 may each extend in the x-direction in the photonic integrated circuit 102. The edge coupler waveguide 104 may include a tapered section 110, a tapered section 112, and a transition section 114 between the tapered sections 110 and 112. The tapered section 110 may be optically coupled with an optical fiber, a fiber optic cable, and/or another type of external optical input. The edge coupler waveguide 104 may be configured to receive input optical signals from the external optical input and to provide the input optical signals to the coupling waveguide 108. Input optical signals may propagate through the edge coupler waveguide 104 in the x-direction.

As further shown in FIG. 1A, the waveguide 106 may include a waveguide of a polarizer, a waveguide of a splitter, a waveguide of an optical modulator, a waveguide of a resonator, a waveguide of a photodetector, and/or a waveguide of another type of photonic component. In some implementations, the waveguide 106 is a polarizer splitter and rotator (PSR) waveguide that includes a through segment 116 and a cross segment 118 that extends alongside the through segment 116 in the x-direction. The through segment 116 may include a tapered section 120, a transition section 122, a dual tapered section 124, a transition section 126, a tapered section 128, and/or an output section 130, among other examples. The through segment 116 may include different types of sections and/or a different arrangement of sections. The cross segment 118 may include a tapered section 132 and an output section 134.

The tapered section 120 of the through segment 116 of the waveguide 106 may be optically coupled and physically coupled with the coupling waveguide 108 such that the input optical signals are received in the waveguide 106 at the tapered section 120. An input optical signal (e.g., an unpolarized input optical signal) may propagate from the tapered section 120 through the transition section 122 and to the dual tapered section 124, where the input optical signal is split into a transverse electric (TE) polarized optical signal and a transverse magnetic™ polarized optical signal. Thus, the dual tapered section 124 may be referred to as the splitter section of the waveguide 106.

The TE polarized optical signal and a TM polarized optical signal propagate through the tapered section 128, where either the TE polarized optical signal or the TM polarized optical signal is coupled to the tapered section 132 of the cross segment 118 and rotated. The optical signal that does not couple to the cross segment 118 continues to propagate through the output section 130 unmodified.

For example, the TE polarized optical signal may couple from the tapered section 128 to the tapered section 132 and may be rotated in the cross segment 118 to become another TM polarized optical signal, whereas the TM polarized optical signal may remain in the through segment 116 and may propagate through to the output section 130.

As another example, the TM polarized optical signal may couple from the tapered section 128 to the tapered section 132 and may be rotated in the cross segment 118 to become another TE polarized optical signal, whereas the TE polarized optical signal may remain in the through segment 116 and may propagate through to the output section 130.

As further shown in FIG. 1A, the coupling waveguide 108 may include a tapered section 136 (e.g., a laterally-tapered section) at a first end of the coupling waveguide 108, a tapered section 138 (e.g., a laterally-tapered section) at a second end of the coupling waveguide 108 opposing the first end, and a transition section 140 between the tapered sections 136 and 138. The coupling waveguide 108 may be located between the edge coupler waveguide 104 and the waveguide 106 in the x-direction.

As shown in FIGS. 1A and 1B the edge coupler waveguide 104 and the coupling waveguide 108 at least partially overlap in a coupling region 142 of the photonic integrated circuit 102. In the coupling region 142, the tapered section 136 at the first end of the coupling waveguide 108 may be at least partially overlapped by the tapered section 112 at an end of the edge coupler waveguide 104 opposing the end of the edge coupler waveguide 104 to which the edge coupler waveguide 104 is optically coupled to the external optical input. The coupling region 142 is where input optical signals transition between the edge coupler waveguide 104 and the coupling waveguide 108.

As further shown in FIGS. 1A and 1B, the waveguide 106 and the coupling waveguide 108 at least partially overlap in another coupling region 144 of the photonic integrated circuit 102. In the coupling region 144, the tapered section 138 at the second end of the coupling waveguide 108 may be at least partially overlapped by the tapered section 120 at an end of the waveguide 106, opposing the end of the waveguide 106 at which the output sections 130 and 134 are located. The coupling region 144 is where input optical signals transition between the waveguide 106 and the coupling waveguide 108.

As shown in FIG. 1B, the edge coupler waveguide 104 may be located at a greater height or greater vertical (z-direction) position in the photonic integrated circuit 102 than the waveguide 106 and the coupling waveguide 108, because the edge coupler waveguide 104 is formed in a dielectric layer that is above the waveguide 106 and the coupling waveguide 108. The edge coupler waveguide 104 may include a dielectric waveguide that includes one or more dielectric materials, whereas the waveguide 106 and the coupling waveguide 108 may each include a semiconductor waveguide that includes one or more semiconductor materials. Examples of dielectric materials that may be included in the edge coupler waveguide 104 include silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials that may be included in the waveguide 106 and in the coupling waveguide 108 include silicon (Si), germanium (Ge), and/or another semiconductor material.

The greater vertical position of the edge coupler waveguide 104 results in the tapered section 112 of the edge coupler waveguide 104 being located above and/or over the tapered section 136 of the coupling waveguide 108 in the coupling region 142. The tapered section 112 of the edge coupler waveguide 104 and the tapered section 136 of the coupling waveguide 108 may be spaced apart in the z-direction in the coupling region 142 such that the edge coupler waveguide 104 and the coupling waveguide 108 are not in physical contact. Input optical signals may propagate downward in the z-direction from the edge coupler waveguide 104 to the coupling waveguide 108 in the coupling region 142.

The tapered section 138 of the coupling waveguide 108 and the tapered section 120 of the waveguide 106 may be physically coupled (e.g., may be in direct physical contact), as well as optically coupled, in the coupling region 144. Input optical signals may propagate upward in the z-direction from the coupling waveguide 108 to the waveguide 106 in the coupling region 144.

As further shown in FIG. 1B, the bottom surfaces of the waveguide 106 and the coupling waveguide 108 may be located at approximately a same height or vertical (z-direction) position in the photonic integrated circuit 102 because of the waveguide 106 and the coupling waveguide 108 being formed from the same semiconductor layer. However, as shown in FIG. 1B, the waveguide 106 may have a greater vertical (z-direction) thickness (indicated in FIG. 1B as a dimension D1) than the vertical (z-direction) thickness the coupling waveguide 108. In some implementations, the vertical thickness of the waveguide 106 may be included in a range of approximately 250 nanometers to approximately 290 nanometers to facilitate efficient operation of the waveguide 106. However, other values and ranges are within the scope of the present disclosure.

A section of the coupling waveguide 108 may have a vertical (z-direction) thickness (dimension D2) that is included in a range of approximately 200 nanometers to approximately 220 nanometers, which facilitates efficient and low-loss optical coupling between the coupling waveguide 108 and the waveguide 106. However, other values and ranges are within the scope of the present disclosure.

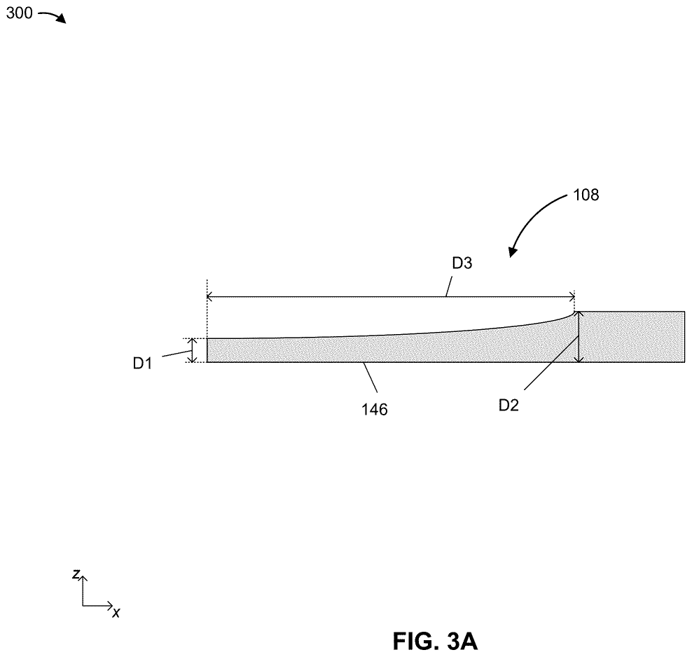

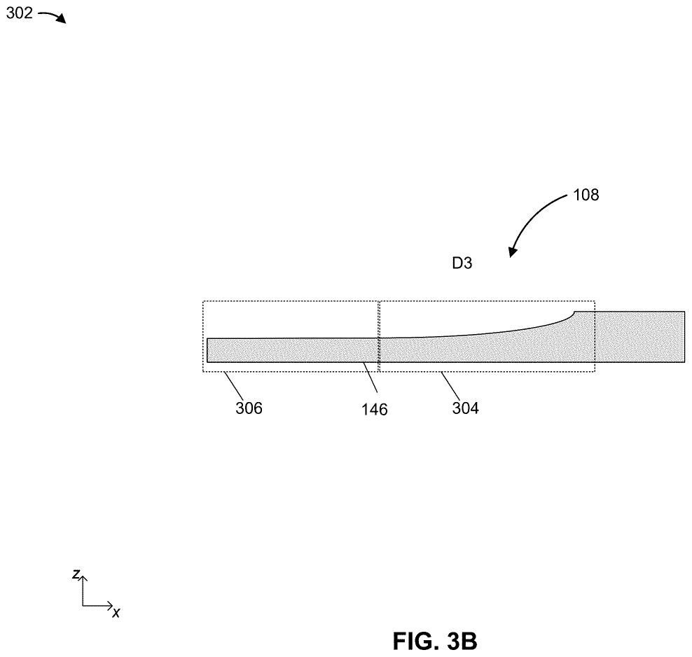

As further shown in FIG. 1B, the coupling waveguide 108 may include a sloped (or vertically tapered) section 146. The sloped section 146 may extend in the x-direction and may be sloped in the z-direction such that the vertical (z-direction) thickness of the coupling waveguide 108 transitions between the vertical (z-direction) thickness at the coupling region 144 and a vertical (z-direction) thickness (dimension D3) at the coupling region 142. In particular, the sloped section 146 may be sloped in the z-direction such that the vertical (z-direction) thickness of the coupling waveguide 108 increases from the vertical (z-direction) thickness (dimension D3) at a first end of the sloped section 146 under the edge coupler waveguide 104 and an opposing end of the sloped section 146 facing the waveguide 106. The slope or vertical taper of the sloped section 146 may be linear (as shown in FIG. 1B), may be non-linear (as shown in an example in FIG. 3), and/or may include a combination of a linear subsection and a non-linear subsection, among other examples.

The lesser vertical (z-direction) thickness (dimension D3) at the end of the coupling region 142 under the edge coupler waveguide 104 enables efficient and low-loss optical coupling to be achieved between the edge coupler waveguide 104 and the coupling waveguide 108. The slope or vertical taper in vertical (z-direction) thickness from the end of the coupling region 142 under the edge coupler waveguide 104 to the end of the coupling region 142 facing the waveguide 106 provides for a gradual increase in vertical (z-direction) thickness along the x-direction in the coupling waveguide 108. This gradual increase reduces the likelihood and/or amount of optical reflections at the transition between the coupling waveguide 108 and the waveguide 106 in the coupling region 144 relative to the vertical (z-direction) thickness transitioned directly between (e.g., included a stepped transition between) the vertical (z-direction) thickness (dimension D3) at the end of the coupling region 142 and the vertical (z-direction) thickness (dimension D1) of the waveguide 106.

In some implementations, the vertical (z-direction) thickness (dimension D3) at the end of the coupling region 142 under the edge coupler waveguide 104 is included in a range of approximately 150 nanometers to approximately 180 nanometers to achieve efficient and low-loss optical coupling to be achieved between the edge coupler waveguide 104 and the coupling waveguide 108. However, other values and ranges are within the scope of the present disclosure.

In some implementations, an x-direction length (dimension D4) of the sloped section 146 is included in a range of approximately 130 nanometers to approximately 170 nanometers to achieve a low amount of optical reflections at the transition between the coupling waveguide 108 and the waveguide 106 in the coupling region 144. However, other values and ranges are within the scope of the present disclosure. In some implementations, a slope of the sloped section 146 may be included in a range of approximately 2 nanometers increase in height per 100 microns of length to approximately 1000 nanometers increase in height per 100 microns in length to achieve a low amount of optical reflections at the transition between the coupling waveguide 108 and the waveguide 106 in the coupling region 144. In some implementations, a slope of the sloped section 146 may be included in a range of approximately 7 nanometers increase in height per 100 microns of length to approximately 8 nanometers increase in height per 100 microns in length to achieve a low amount of optical reflections at the transition between the coupling waveguide 108 and the waveguide 106 in the coupling region 144. However, other values and ranges are within the scope of the present disclosure.

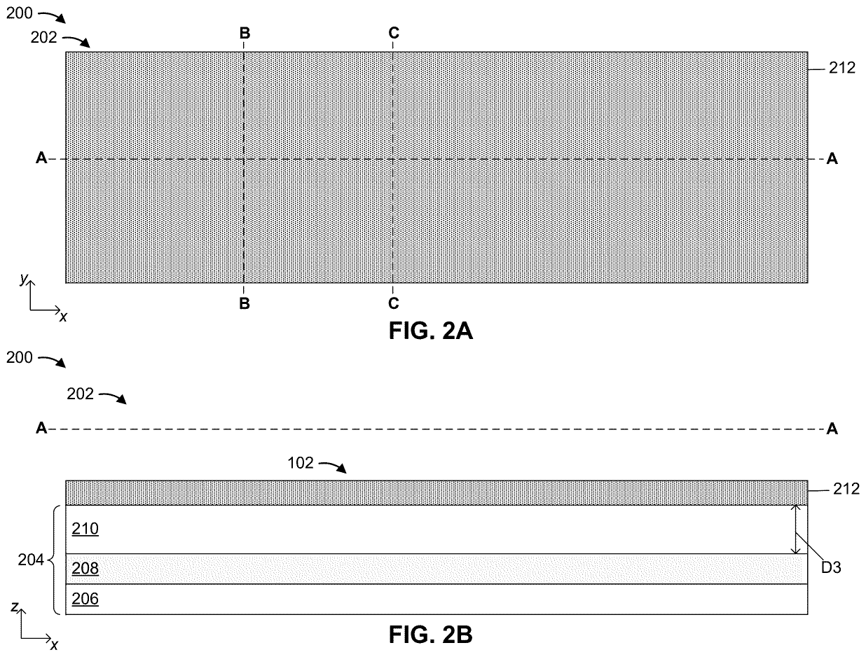

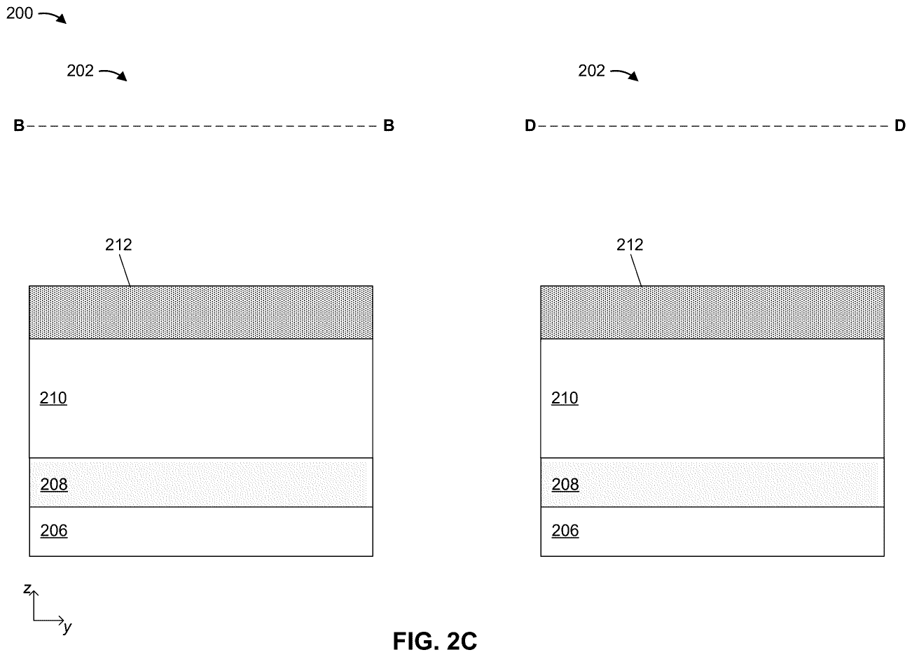

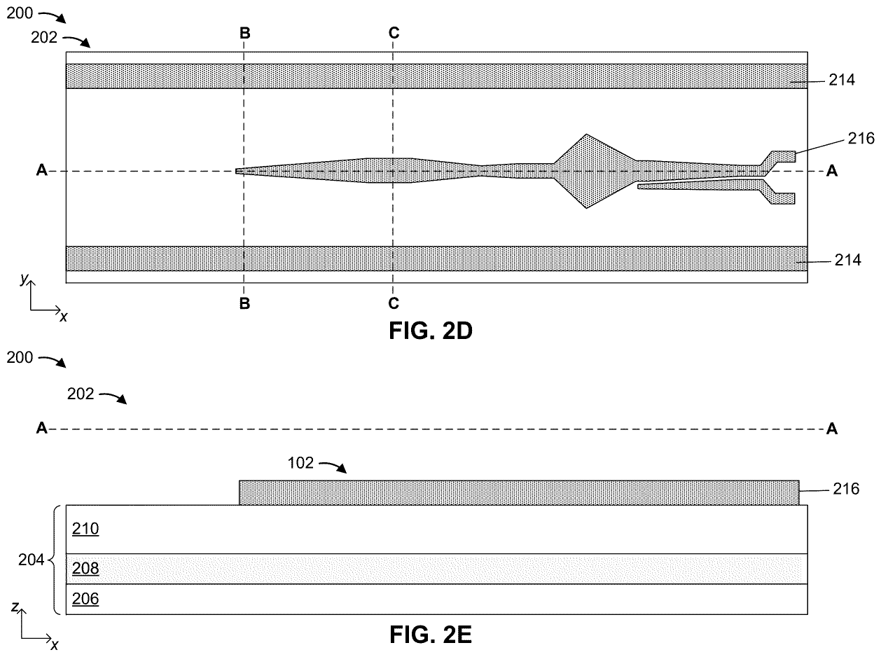

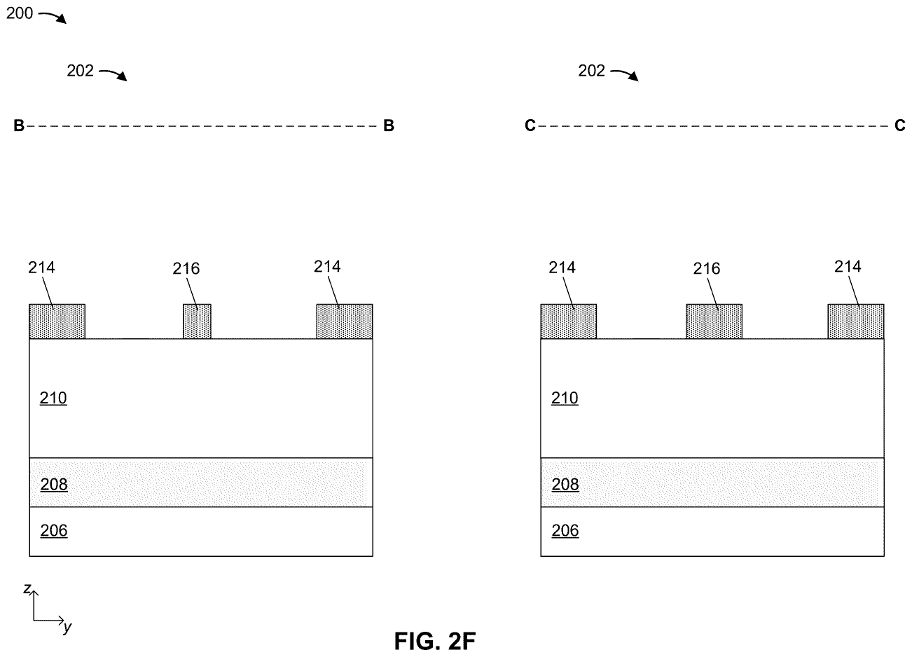

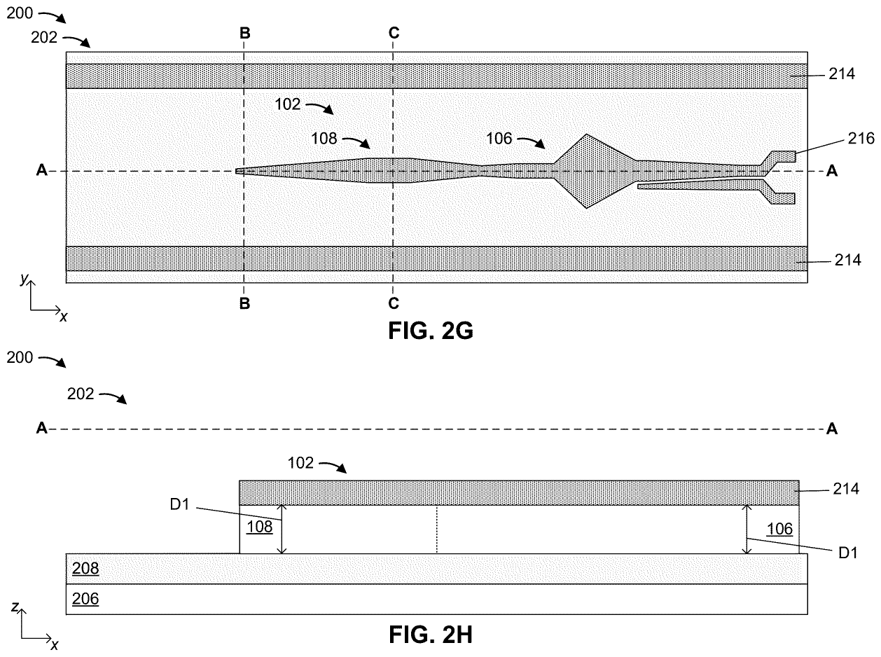

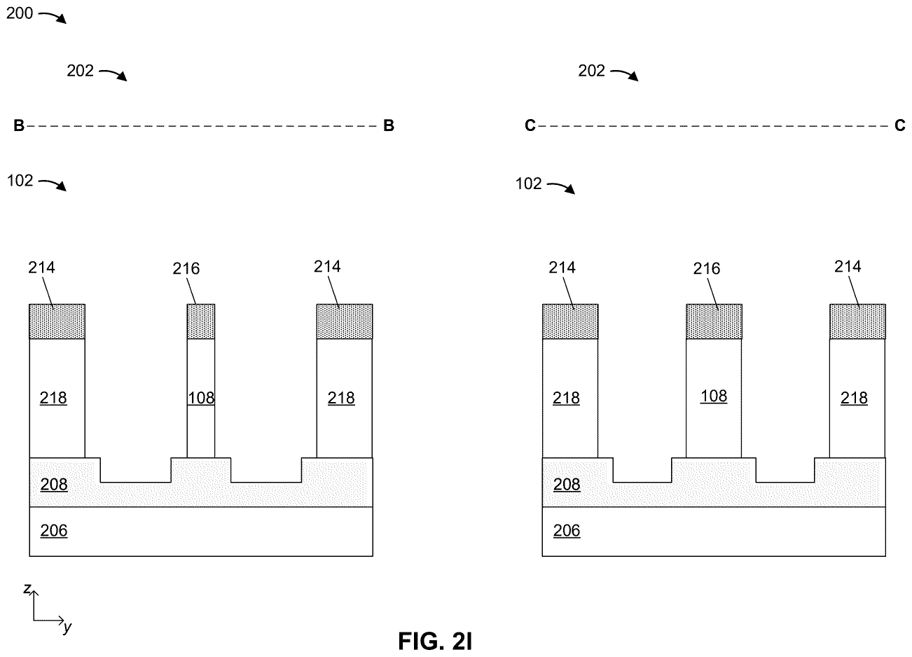

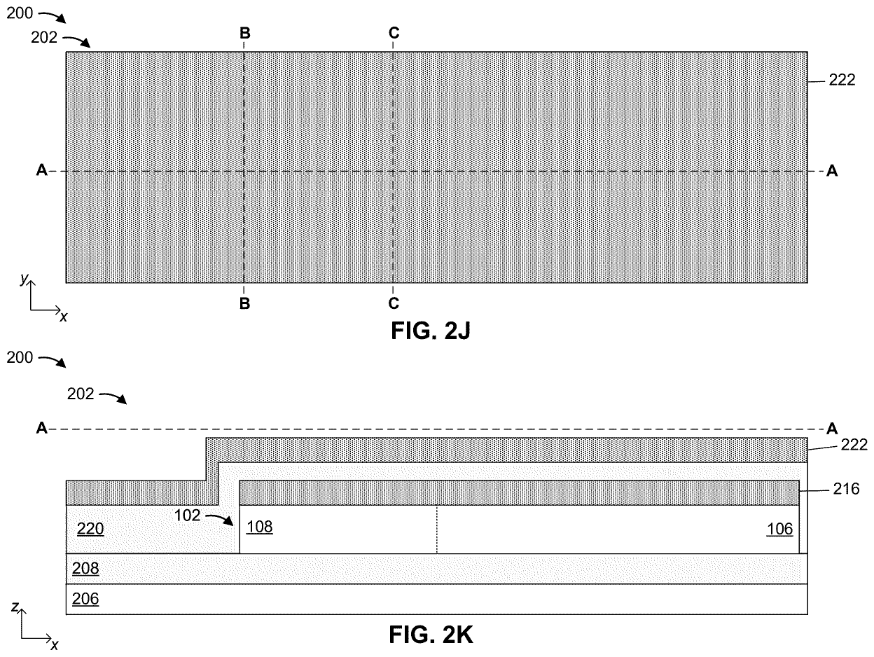

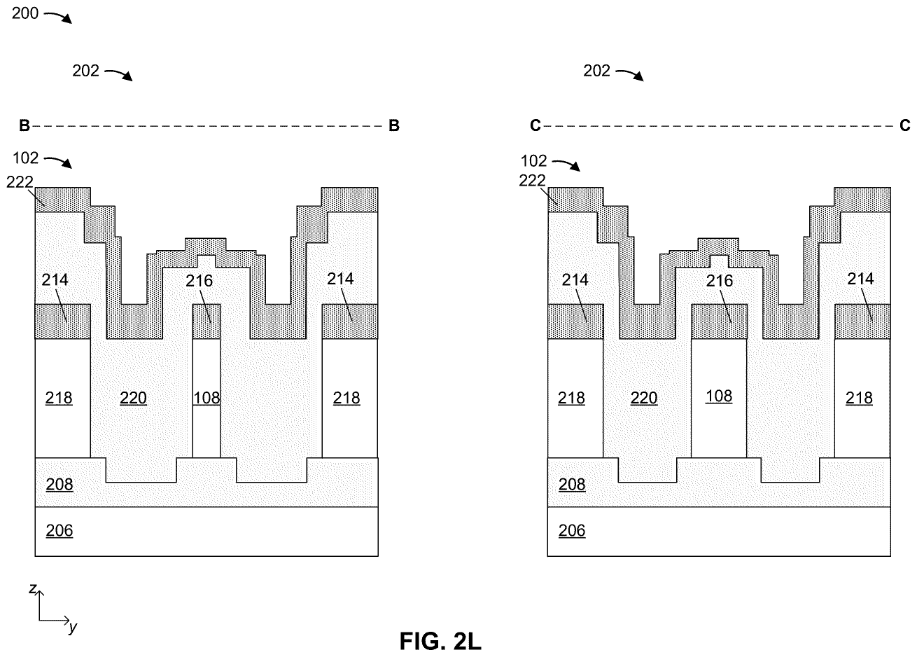

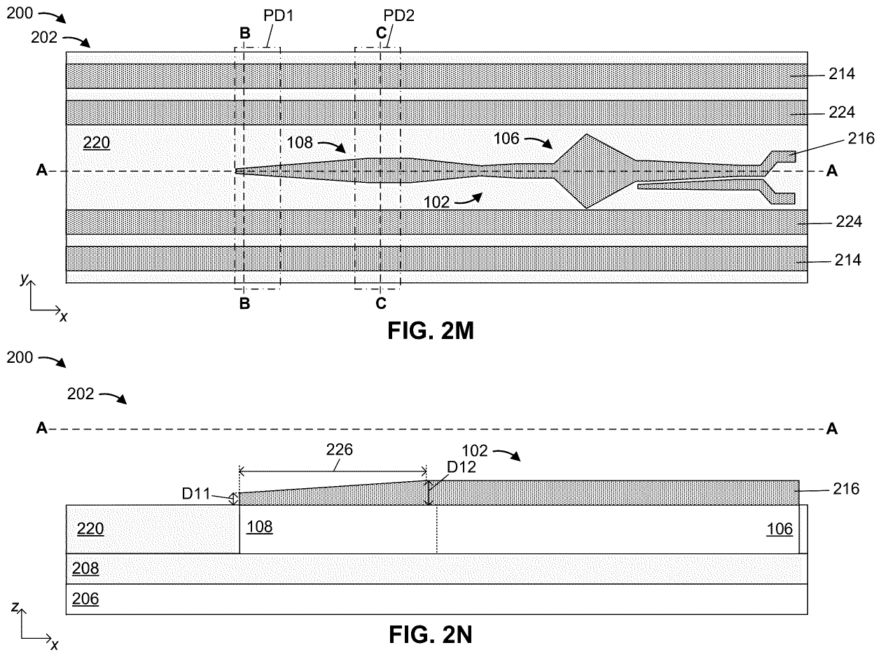

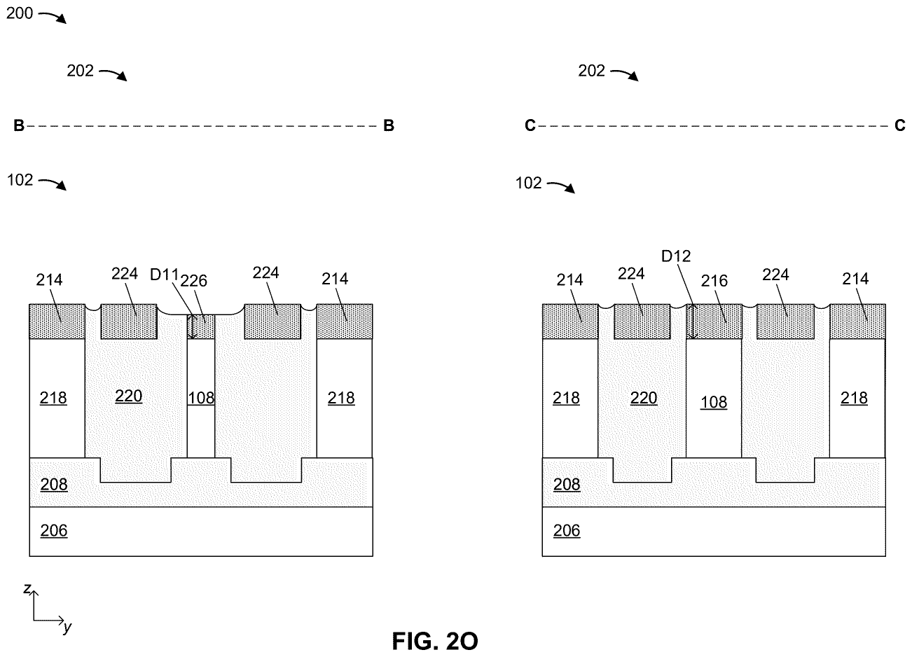

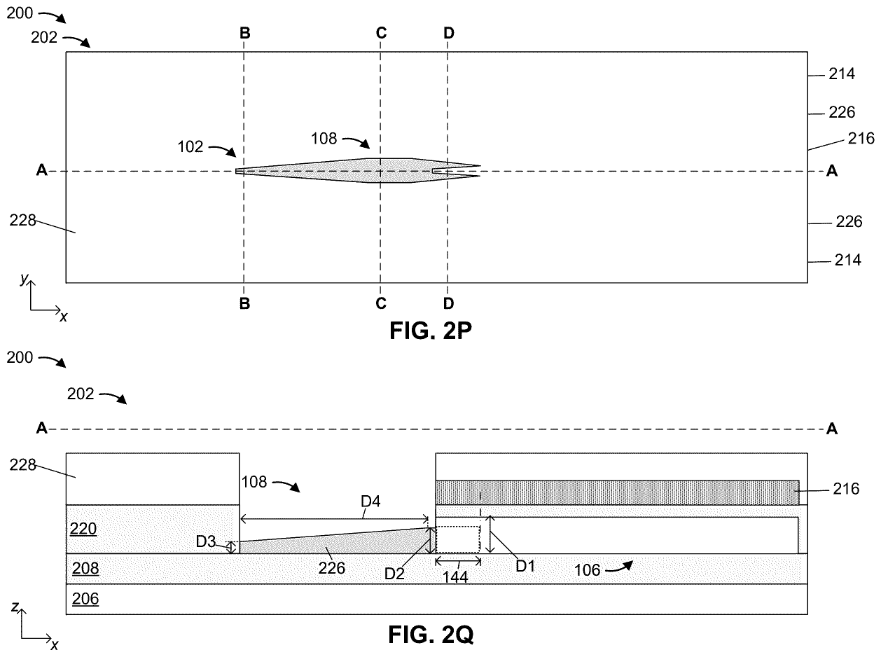

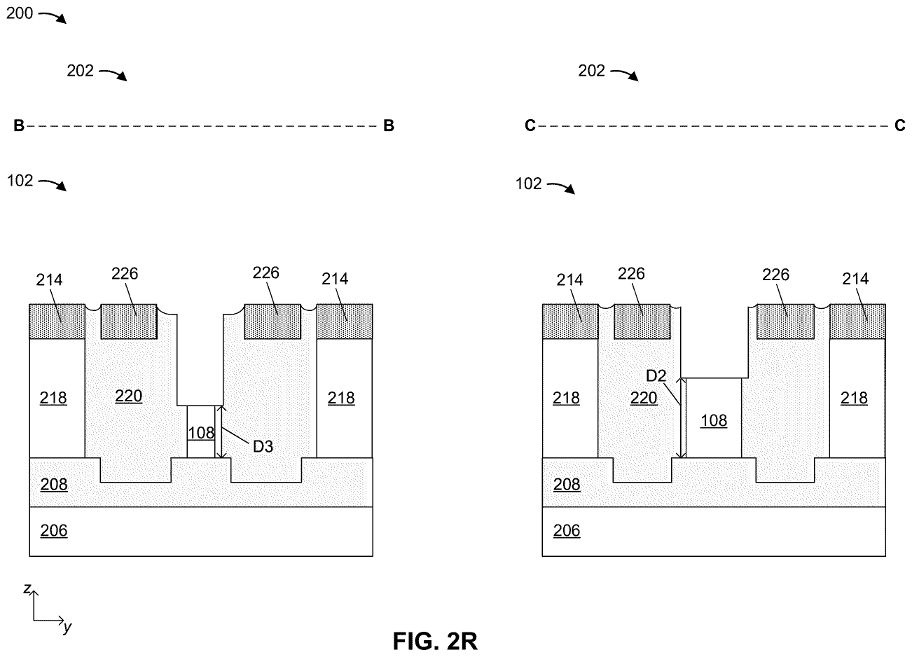

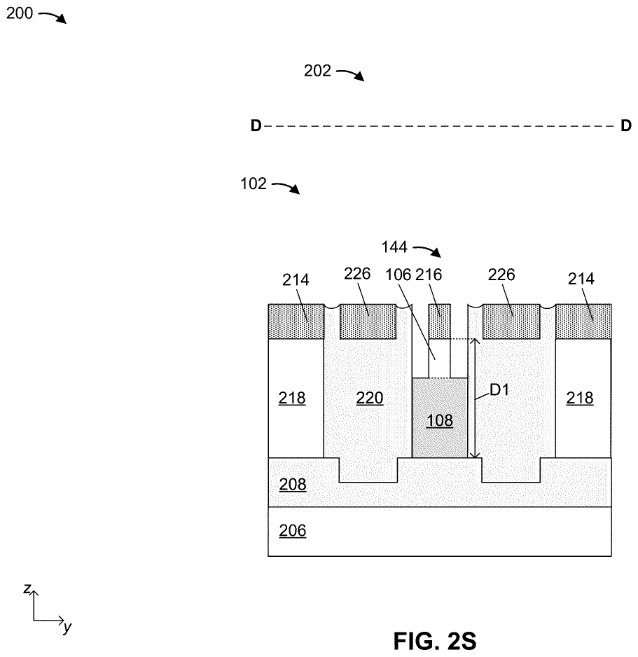

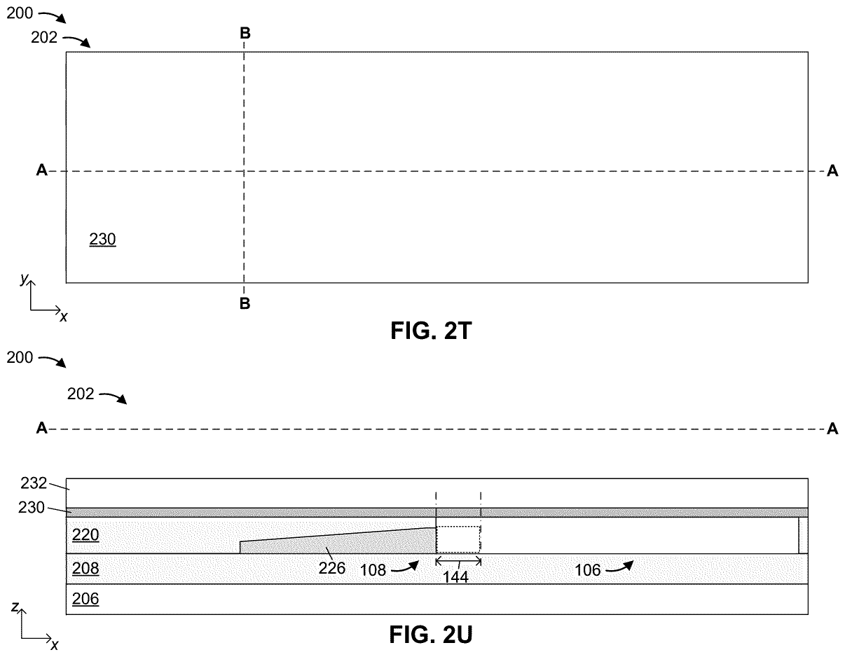

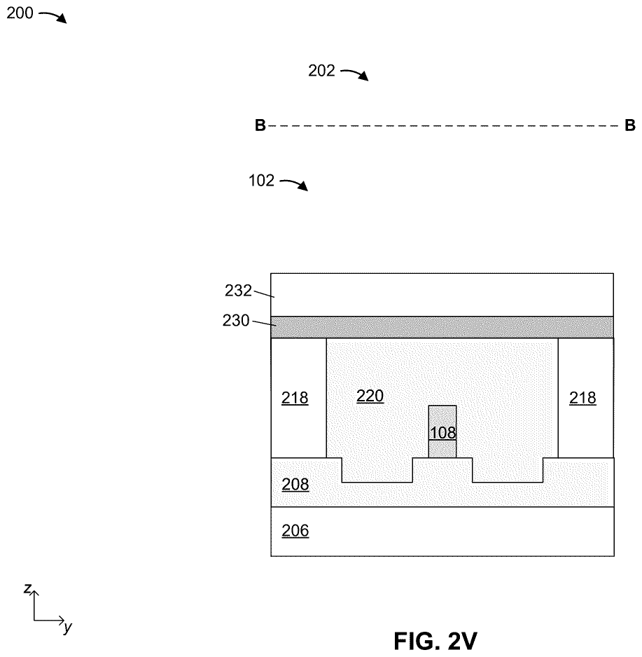

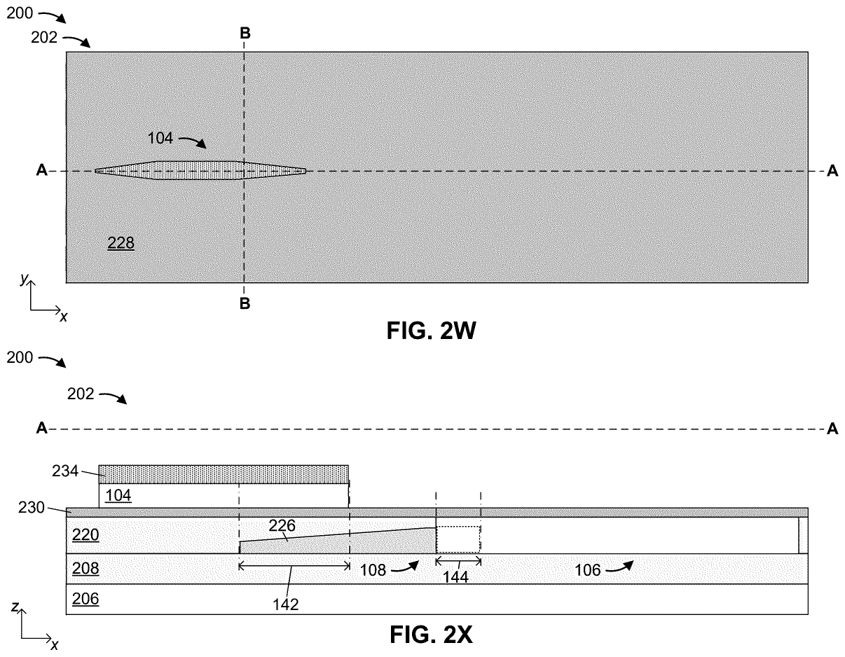

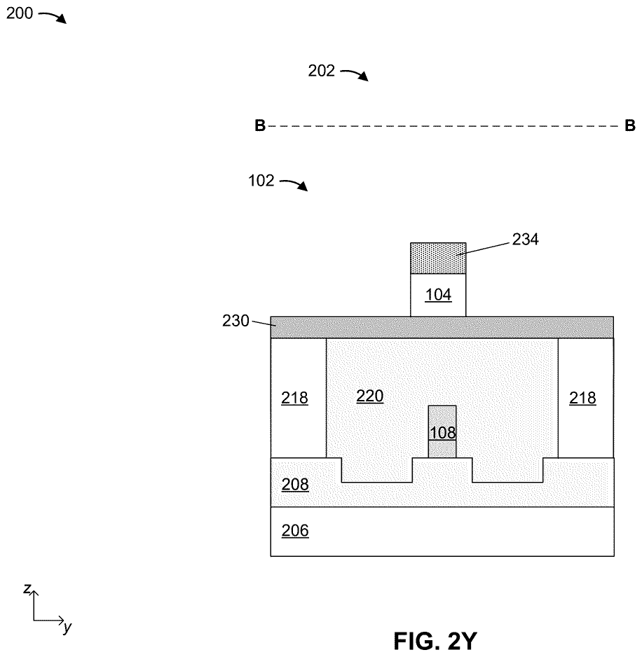

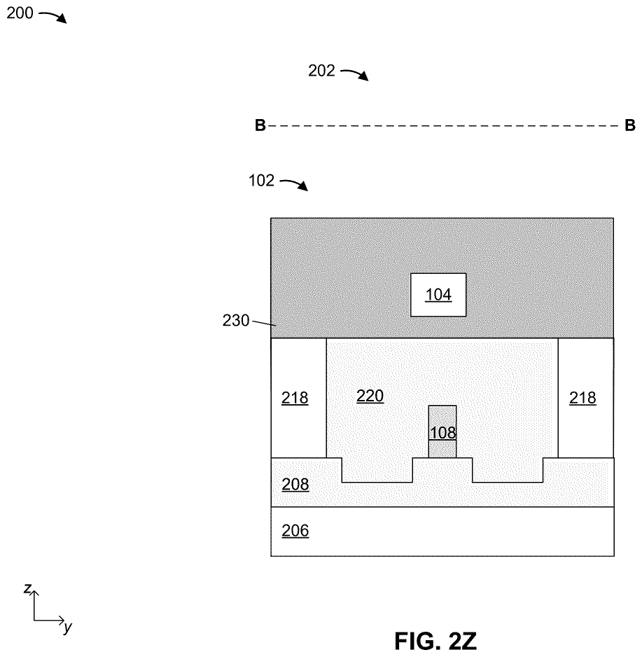

The waveguide 106 and the coupling waveguide 108 may be manufactured from the semiconductor layer, using techniques described herein (such as in connection with FIGS. 2A-2Z), such that the coupling waveguide 108 has a lesser vertical (z-direction) thickness than the waveguide 106. Moreover, the waveguide 106 and the coupling waveguide 108 may be manufactured from the semiconductor layer, using techniques described herein (such as in connection with FIGS. 2A-2Z), such that the sloped section 146 is formed in the coupling waveguide 108. In particular, a pattern in a hard mask may be formed to have a sloped (or vertically tapered) section using various planarization techniques described in connection with FIGS. 2A-2Z, and the semiconductor layer may be etched to transfer the sloped section of the pattern in the hard mask to the semiconductor layer, thereby forming the sloped section 146 in the coupling waveguide 108.

As shown in FIG. 1C, the edge coupler waveguide 104, the waveguide 106, and the coupling waveguide 108 may each include a strip waveguide cross-sectional profile, except in the coupling region 144 where the combination of the waveguide 106 and coupling waveguide 108 corresponds to a slab waveguide cross-sectional profile. The slab waveguide cross-sectional profile occurs due to the waveguide 106 being located on top of (and in physical contact with) the coupling waveguide 108 in the coupling region 144, as shown in the C-C cross-section in FIG. 1C.

As further shown in FIG. 1C, a cross-sectional width (dimension D5) of the edge coupler waveguide 104 in the y-direction is greater than a cross-sectional width (dimension D6) of the coupling waveguide 108 in the y-direction at the location of the B-B cross-section. A cross-sectional width (dimension D7) of the coupling waveguide 108 in the y-direction at the location of the C-C cross-section is greater than the cross-sectional width (dimension D6) of the coupling waveguide 108 in the y-direction at the location of the B-B cross-section. This occurs due to the cross-sectional width of the coupling waveguide 108 increasing from the end facing the edge coupler waveguide 104 toward the transition section 140 along the x-direction.

As further shown in FIG. 1C, a cross-sectional width (dimension D8) of the waveguide 106 in the y-direction may be less than a cross-sectional width (dimension D9) of the coupling waveguide 108 in the y-direction at the location of the D-D cross-section, and a cross-sectional width (dimension D10) of the waveguide 106 in the y-direction at the location of the D-D cross-section may be greater than the cross-sectional width (dimension D9) of the coupling waveguide 108 in the y-direction at the location of the D-D cross-section. This occurs due to the cross-sectional width of the waveguide 106 increasing from the end facing the coupling waveguide 108 toward the transition section 126.

As indicated above, FIGS. 1A-1C are provided as an example. Other examples may differ from what is described with regard to FIGS. 1A-1C.

FIGS. 2A-2Z are diagrams of an example implementation 200 of forming the photonic integrated circuit 102 described herein. In some implementations, one or more of the semiconductor processing operations described in connection with FIGS. 2A-2Z may be performed using one or more semiconductor processing tools, such as a deposition tool, an exposure tool, a developer tool, an etch tool, a planarization tool, a plating tool, an ion implantation tool, and/or a wafer/die transport tool, among other examples. FIGS. 2A-2Z are illustrated from one or more of the top view in FIG. 1A, the cross-section view along line A-A in FIG. 1B, and/or the cross-section views along lines B-B, C-C, D-D, and/or E-E in FIG. 1C.

Turning to FIGS. 2A-2C, a semiconductor device 202 may be provided. The semiconductor device 202 may be provided as a substrate 204, which may include a silicon-on-insulator (SOI) substrate (or SOI wafer) and/or another type of substrate. The substrate 204 may include a semiconductor substrate 206 (e.g., a silicon (Si) substrate and/or another type of semiconductor substrate), a dielectric layer 208 (e.g., a buried oxide or bottom oxide (BOX) layer and/or another type of insulator layer) over and/or on the semiconductor substrate 206, and a semiconductor layer 210 (e.g., a silicon (Si) layer and/or another type of semiconductor layer) over and/or on the dielectric layer 208.

Alternatively, the semiconductor substrate 206 may be provided as a semiconductor wafer, a deposition tool may be used to form the dielectric layer 208 over and/or on the semiconductor substrate 206, and a deposition tool may form the semiconductor layer 210 over and/or on the dielectric layer 208. A deposition tool may be used to form the dielectric layer 208 using a chemical vapor deposition (CVD) technique, a physical vapor deposition (PVD) technique, an oxidation technique (e.g., a thermal oxidation technique), and/or another type of deposition technique. A deposition tool may be used to form the semiconductor layer 210 using a CVD technique, a PVD technique, an epitaxy technique, and/or another type of deposition technique.

As further shown in FIGS. 2A-2C, a masking layer 212 is formed over and/or on the semiconductor layer 210. The masking layer 212 may include a dielectric material, such as a silicon oxide (SiOₓ), a silicon nitride (SiₓN_{y}), a silicon oxynitride (SiON), and/or another suitable dielectric material. A deposition tool may be used to form the masking layer 212 using a CVD technique, a PVD technique, an atomic layer deposition (ALD) technique, an oxidation technique (e.g., a thermal oxidation technique), and/or another type of deposition technique.

As shown in FIGS. 2D-2F, the masking layer 212 may be patterned and etched to form patterned masking segments 214 that extend along opposing sides of a photonic integrated circuit pattern 216. The patterned masking segments 214 may extend along opposing sides of the photonic integrated circuit pattern 216 in the x-direction.

In some implementations, a pattern in a photoresist layer is used to etch the masking layer 212 to form the patterned masking segments 214 and the photonic integrated circuit pattern 216. In these implementations, a deposition tool may be used to form the photoresist layer on the masking layer 212 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the masking layer 212 based on the pattern to form the patterned masking segments 214 and the photonic integrated circuit pattern 216. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique).

As shown in FIGS. 2G-2I, the semiconductor layer 210 may be etched based on the patterned masking segments 214 and the photonic integrated circuit pattern 216. An etch tool may be used to etch the semiconductor layer 210 based on the patterned masking segments 214 and the photonic integrated circuit pattern 216 to form the waveguide 106 and the coupling waveguide 108 each to a first depth in the semiconductor layer 210 (corresponding to the dimension D1). The etching of the semiconductor layer 210 may define pad segments 218 under the patterned masking segments 214. In some implementations, the etch operation includes a plasma etch operation, a wet chemical etch operation, and/or another type of etch operation.

As shown in FIGS. 2J-2L, a dielectric layer 220 may be formed over the exposed portions of the dielectric layer 208, over the patterned masking segments 214, and over the photonic integrated circuit pattern 216. The dielectric layer 220 may be referred to as a shallow trench isolation (STI) layer. A deposition tool may be used to deposit the dielectric layer 220 using a PVD technique, an ALD technique, a CVD technique, an oxidation technique, and/or another suitable deposition technique.

As further shown in FIGS. 2J-2L, another masking layer 222 may be formed over and/or on the dielectric layer 220. A deposition tool may be used to deposit the dielectric layer 220 using a PVD technique, an ALD technique, a CVD technique, an oxidation technique, and/or another suitable deposition technique. Portions of the dielectric layer 220 and portions of the masking layer 222 may be formed over the patterned masking segments 214 and the photonic integrated circuit pattern 216.

In some implementations, the masking layer 222, the patterned masking segments 214, and the photonic integrated circuit pattern 216 may include the same material, which may be different from the material of the dielectric layer 220. For example, the dielectric layer 220 may include a silicon oxide (SiOₓ such as SiO₂), and the patterned masking segments 214, the photonic integrated circuit pattern 216, and the masking layer 222 may include a silicon nitride (SiₓN_{y} such as Si₃N₄). However, other combinations of materials for the patterned masking segments 214, the photonic integrated circuit pattern 216, the dielectric layer 220, and the masking layer 222 are within the scope of the present disclosure.

The different materials for the dielectric layer 220 and the photonic integrated circuit pattern 216, and the masking layer 222 enable different material removal rates (e.g., different selectivity) for the dielectric layer 220, the photonic integrated circuit pattern 216, and the masking layer 222 to be achieved in a subsequent planarization operation. The different material removal rates enable a sloped pattern section to be formed in the photonic integrated circuit pattern 216 during the planarization operation.

As shown in FIGS. 2M-2O, a planarization operation is performed to planarize the dielectric layer 220 and the masking layer 222. A planarization tool (e.g., a CMP tool) may be used to perform the planarization operation (e.g., a CMP operation) to planarize the dielectric layer 220 and the masking layer 222. The planarization operation may result in removal of material of the dielectric layer 220 and the masking layer 222 that is located over the patterned masking segments 214 and that is located over the photonic integrated circuit pattern 216, thereby resulting in formation of additional patterned masking segments 224. The patterned masking segments 224 may extend approximately parallel to the patterned masking segments 214, and the patterned masking segments 224 may be located laterally between the patterned masking segments 214 and the photonic integrated circuit pattern 216.

The patterned masking segments 224 may be formed to achieve a particular pattern density along the photonic integrated circuit pattern 216. For example, and as shown in FIG. 2M, a pattern area PD1 at the end of the coupling waveguide 108 opposing the waveguide 106 may have a first pattern density of oxide material (e.g., a percentage of the pattern area PD1 occupied by the dielectric layer 220), and a pattern area PD2 along the coupling waveguide 108 closer to the waveguide 106 may have a second pattern density of oxide material (e.g., a percentage of the pattern area PD2 occupied by the dielectric layer 220) that is greater than the first pattern density of oxide material in the pattern area PD1. The pattern density of oxide material may increase along the length of the coupling waveguide 108 in the x-direction between the pattern area PD2 and the pattern area PD1.

The variable pattern density of oxide material along the length of the coupling waveguide 108 in the x-direction between the pattern area PD2 and the pattern area PD1, alone or in combination with a selectivity of a planarization slurry that is used in the planarization operation, may result in a sloped pattern section 226 being formed in a portion of the photonic integrated circuit pattern 216 along the length of the coupling waveguide 108 in the x-direction between the pattern area PD2 and the pattern area PD1. For example, the planarization operation may be planarized using a planarization slurry that has a material removal rate for the material (e.g., a silicon nitride (SiₓN_{y}) material or another suitable material) of the photonic integrated circuit pattern 216 that is greater than a material removal rate for the material (e.g., a silicon oxide (SiOₓ) material or another suitable material) of the dielectric layer 220. The greater material removal rate for the material of the photonic integrated circuit pattern 216, in combination with the photonic integrated circuit pattern 216 occupying a lesser amount of the area in the pattern area PD1 than in the pattern area PD2, results in a greater amount of material being removed from the photonic integrated circuit pattern 216 in the pattern area PD1 than in the pattern area PD2 during the planarization operation.

In some implementations, the amount of material removed from the photonic integrated circuit pattern 216 in the pattern area PD1 relative to the amount of material removed from the photonic integrated circuit pattern 216 in the pattern area PD2 may be further increased by using a relatively soft planarization pad in the planarization operation. For example, the planarization pad may have a modulus that is less than approximately 200 megapascals (MPa), which promotes the occurrence and/or the amount of dishing in the planarization operation. Because of the greater density of oxide material in the pattern area PD1 relative to the pattern area PD2, and because of the greater removal rate of the planarization slurry for the material of the photonic integrated circuit pattern 216 relative to the material of the dielectric layer 220, the dishing may be more pronounced in the pattern area PD1, which may further promote the formation of the sloped pattern section 226 in the photonic integrated circuit pattern 216.

As shown in FIGS. 2N and 2O, a first end of the sloped pattern section 226 may have a vertical (z-direction) thickness (dimension D11) that is less than a vertical (z-direction) thickness (dimension D12) of a second end of the sloped pattern section 226 facing the waveguide 106. The vertical (z-direction) thickness of the sloped pattern section 226 may increase (e.g., linearly, non-linearly) from the first end of the sloped pattern section 226 to the second end of the sloped pattern section 226.

As shown in FIGS. 2P-2S, the coupling waveguide 108 may be etched to reduce the vertical (z-direction) thickness of the coupling waveguide 108, which defines the tapered section 138 of the waveguide 106. An etch tool may be used to perform an etch operation to etch the coupling waveguide 108 to reduce a z-direction thickness of the coupling waveguide 108. In some implementations, the etch operation includes a plasma etch operation, a wet chemical etch operation, and/or another type of etch operation.

As shown in FIGS. 2Q and 2S, the etch operation results in formation of the coupling region 144 between the coupling waveguide 108 and the waveguide 106. Moreover, because of the sloped pattern section 226 being formed in the photonic integrated circuit pattern 216, the sloped pattern section 226 of the photonic integrated circuit pattern 216 is removed at the first end of the sloped pattern section 226 having the lesser thickness (dimension D11) before being fully removed at the second end having the greater thickness (dimension D12). In particular, the sloped pattern section 226 of the photonic integrated circuit pattern 216 is gradually etched through from the first end to the second end during the etch operation. As the sloped pattern section 226 is gradually etched through, portions of the underlying coupling waveguide 108 are also gradually etched. The gradual etching of the coupling waveguide 108 as the sloped pattern section 226 is etched through results in formation of the sloped section 146 in the coupling waveguide 108. As a result, the end of the coupling waveguide 108 under the first end of the sloped pattern section 226 having the lesser thickness (dimension D11) may have a lesser thickness (dimension D3) after the etch operation than the thickness (dimension D1) of a portion of the coupling waveguide 108 under the second end having the greater thickness (dimension D12).

In some implementations, the slope of the sloped section 146 may be different from the slope of the sloped pattern section 226. This may occur, for example, due to an etch rate of the semiconductor material of the coupling waveguide 108 being greater in the etch operation than the etch rate of the dielectric material of the sloped pattern section 226. For example, an etch rate of the silicon (Si) material of the coupling waveguide 108 may be greater in the etch operation than the etch rate of the silicon nitride (SiₓN_{y}) material of the sloped pattern section 226. As a result, the sloped section 146 of the coupling waveguide 108 may have a greater slope than the sloped pattern section 226 of the photonic integrated circuit pattern 216. For example, the slope of the sloped pattern section 226 of the photonic integrated circuit pattern 216 may be included in a range of approximately 4 nanometers increase in thickness over 100 microns of length along the photonic integrated circuit pattern 216 to approximately 5 nanometers increase in thickness over 100 microns of length along the photonic integrated circuit pattern 216, whereas the slope of the sloped section 146 of the coupling waveguide 108 may be included in a range of approximately 7 nanometers increase in height per 100 nanometers of length to approximately 8 nanometers increase in height per 100 nanometers. However, other values and ranges for the slope of the sloped pattern section 226 of the photonic integrated circuit pattern 216 and for the slope of the sloped section 146 of the coupling waveguide 108 are within the scope of the present disclosure.

The photonic integrated circuit pattern 216 protects the waveguide 106 from being etched in the etching operation. As shown in FIGS. 2P and 2Q, in some implementations, an additional masking layer 228 may be formed on the portion of the photonic integrated circuit pattern 216 that is over a portion of the semiconductor layer 210 in which the waveguide 106 is to be formed, and this additional masking layer 228 may further protect the waveguide 106 from being etched in the etching operation. Accordingly, and as shown in FIG. 2S, the waveguide 106 remains at approximately a same thickness (dimension D1) after the etch operation.

As shown in FIGS. 2T-2V, the dielectric layer 220 (e.g., the STI layer) is rebuilt after the etch operation described in connection with FIGS. 2P-2S. A deposition tool may be used to deposit the additional material of the dielectric layer 220 using a CVD technique, a PVD technique, an oxidation technique (e.g., a thermal oxidation technique), and/or another type of deposition technique. A planarization tool is used to perform a planarization operation to planarize the dielectric layer 220 after the additional material of the dielectric layer 220 is deposited. The remaining portions of the masking layer 212 may also be removed in the planarization operation. In some implementations, the dielectric layer 220 may be planarized such that the top surface of the dielectric layer 220 is approximately co-planar with the top surface of the waveguide 106. The coupling waveguide 108 may be encapsulated in the dielectric layer 220 due to the z-direction thickness of the waveguide 106 being greater than the z-direction thickness of the coupling waveguide 108.

As further shown in FIGS. 2T-2V, another dielectric layer 230 (e.g., an interlayer dielectric (ILD) layer) is formed over and/or on the dielectric layer 220, over and/or on the waveguide 106, and/or above the coupling waveguide 108. A deposition tool may be used to deposit the dielectric layer 230 using a CVD technique, a PVD technique, an oxidation technique (e.g., a thermal oxidation technique), and/or another type of deposition technique. In some implementations, a planarization tool is used to perform a planarization operation to planarize the dielectric layer 230 after the dielectric layer 230 is deposited. The dielectric layer 230 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

As further shown in FIGS. 2T-2V, another dielectric layer 232 is formed over and/or on the dielectric layer 230. A deposition tool may be used to deposit the dielectric layer 232 using a CVD technique, a PVD technique, an oxidation technique (e.g., a thermal oxidation technique), and/or another type of deposition technique. In some implementations, a planarization tool is used to perform a planarization operation to planarize the dielectric layer 232 after the dielectric layer 232 is deposited. The edge coupler waveguide 104 may be formed from the dielectric layer 232. Accordingly, the dielectric layer 232 may include one or more dielectric materials, such as a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples.

As shown in FIGS. 2W-2Y, a patterned masking layer 234 (e.g., a patterned photoresist layer) may be used to etch the dielectric layer 232 to form the edge coupler waveguide 104 from the dielectric layer 232. In some implementations, a deposition tool may be used to form a photoresist layer on the dielectric layer 232 using a spin-coating technique and/or another suitable type of deposition technique. An exposure tool may be used to expose the photoresist layer to a radiation source to form a pattern in the photoresist layer. A developer tool may be used to develop and remove portions of the photoresist layer to expose the pattern, thereby resulting in the patterned masking layer 234. The dielectric layer 232 may then be etched based on the pattern in the masking layer 234 to form the edge coupler waveguide 104. In some implementations, the etch operation includes a plasma etch operation, a wet chemical etch operation, and/or another type of etch operation. The dielectric layer 232 is etched such that the tapered section 112 of the edge coupler waveguide 104 is formed over a portion of the coupling waveguide 108 (e.g., the tapered section 136 of the coupling waveguide 108), which results in formation of the coupling region 142 between the edge coupler waveguide 104 and the coupling waveguide 108.

As shown in FIG. 2Z, additional material of the dielectric layer 230 is deposited. A deposition tool may be used to deposit the additional material of the dielectric layer 230 using a CVD technique, a PVD technique, an oxidation technique (e.g., a thermal oxidation technique), and/or another type of deposition technique. A planarization tool is used to perform a planarization operation to planarize the dielectric layer 230 after the additional material of the dielectric layer 230 is deposited. The edge coupler waveguide 104 may be encapsulated in the dielectric layer 230 after the additional material of the dielectric layer 230 is deposited.

As indicated above, FIGS. 2A-2Z are provided as an example. Other examples may differ from what is described with regard to FIGS. 2A-2Z.

FIGS. 3A and 3B are diagrams of example implementations of a sloped section 146 of a coupling waveguide 108 described herein. As shown in FIGS. 3A and 3B, the sloped section 146 may have a non-linear slope. In other words, the vertical (z-direction) thickness of the sloped section 146 in the FIGS. 3A and 3B increases in a non-linear manner along at least a portion of the length of the sloped section 146 from the end of the sloped section 146 under the edge coupler waveguide 104 and the opposing end of the sloped section 146 facing the waveguide 106.

The non-linear slope of the sloped section 146 may result in the top surface of the sloped section 146 being at least partially curved. The slope of the sloped section 146 may have multiple slope values corresponding to different tangent lines at different points along at least a portion of the curve of the top surface of the sloped section 146.

In an example implementation 300 illustrated in FIG. 3A, the top surface of the sloped section 146 is curved along the full length of the sloped section 146 in the x-direction. In an example implementation 302 illustrated in FIG. 3B, the top surface of the sloped section 146 is curved along less than the full length of the sloped section 146 in the x-direction. For example, a curved portion 304 may be located closer to the waveguide 106 than a non-curved portion 306 adjacent to the edge coupler waveguide 104.

In some implementations, the curve in the top surface of the sloped section 146 of the coupling waveguide 108 may result from the sloped pattern section 226 of the photonic integrated circuit pattern 216 being formed to have a non-linear or curved top surface. This may occur, for example, where a removal rate of material from the photonic integrated circuit pattern 216 in the sloped pattern section 226 is non-uniform, which may occur due to deformation of the CMP pad used to planarize the sloped pattern section 226 photonic integrated circuit pattern 216, the selectivity of the slurry used to planarize the photonic integrated circuit pattern 216, and/or the pattern density in the region of the sloped pattern section 226, among other examples.

As indicated above, FIG. 3 is provided as an example. Other examples may differ from what is described with regard to FIG. 3.

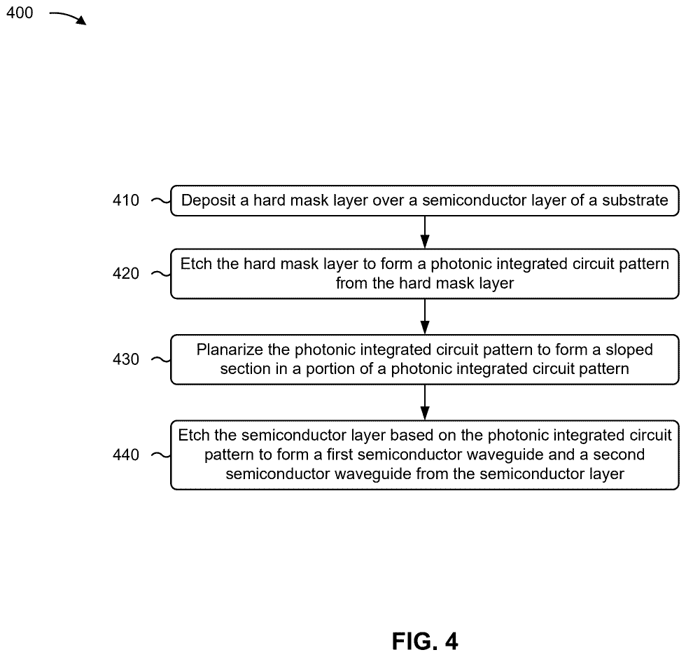

FIG. 4 is a flowchart of an example process 400 associated with forming a photonic integrated circuit described herein. In some implementations, one or more process blocks of FIG. 4 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 4, process 400 may include depositing a hard mask layer over a semiconductor layer of a substrate (block 410). For example, one or more semiconductor processing tools may be used to deposit a hard mask layer (e.g., a masking layer 212) over a semiconductor layer (e.g., a semiconductor layer 210) of a substrate (e.g., a substrate 204), as described herein.

As further shown in FIG. 4, process 400 may include etching the hard mask layer to form a photonic integrated circuit pattern from the hard mask layer (block 420). For example, one or more semiconductor processing tools may be used to etch the hard mask layer to form a photonic integrated circuit pattern (e.g., a photonic integrated circuit pattern 216) from the hard mask layer, as described herein.

As further shown in FIG. 4, process 400 may include planarizing the photonic integrated circuit pattern to form a sloped section in a portion of a photonic integrated circuit pattern (block 430). For example, one or more semiconductor processing tools may be used to planarize the photonic integrated circuit pattern to form a sloped section (e.g., a sloped section 226) in a portion of a photonic integrated circuit pattern, as described herein.

As further shown in FIG. 4, process 400 may include etching the semiconductor layer based on the photonic integrated circuit pattern to form a first semiconductor waveguide and a second semiconductor waveguide from the semiconductor layer (block 440). For example, one or more semiconductor processing tools may be used to etch the semiconductor layer based on the photonic integrated circuit pattern to form a first semiconductor waveguide (e.g., a coupling waveguide 108) and a second semiconductor waveguide (e.g., a waveguide 106) from the semiconductor layer, as described herein. In some implementations, the sloped section of the photonic integrated circuit pattern is etched through to form a sloped section (e.g., a sloped section 146) in the first semiconductor waveguide.

Process 400 may include additional implementations, such as any single implementation or any combination of implementations described below and/or in connection with one or more other processes described elsewhere herein.

In a first implementation, a first pattern density of oxide material (e.g., a dielectric layer 220) in an area (e.g., a pattern area PD1) of the semiconductor layer that is to be etched to form a first end of the sloped section in the first semiconductor waveguide is greater than a second pattern density of oxide material (e.g., the dielectric layer 220 220) in an area (e.g., a pattern area PD2) of the semiconductor layer that is to be etched to form a second end of the sloped section in the first semiconductor waveguide.

In a second implementation, alone or in combination with the first implementation, planarizing the photonic integrated circuit pattern includes planarizing the photonic integrated circuit pattern using a planarization slurry that has a material removal rate for a material of the photonic integrated circuit pattern that is greater than a material removal rate for the oxide material.

In a third implementation, alone or in combination with one or more of the first and second implementations, process 400 includes etching the hard mask layer to form first pattern segments (e.g., patterned masking segments 214) along opposing sides of the photonic integrated circuit pattern, depositing another hard mask layer (e.g., a hard masking layer 222) above the photonic integrated circuit pattern and above the first pattern segments, and planarizing the other hard mask layer to form second pattern segments (e.g., pattern segments 224) between the photonic integrated circuit pattern and the first pattern segments.

In a fourth implementation, alone or in combination with one or more of the first through third implementations, etching the semiconductor layer based on the photonic integrated circuit pattern includes etching the semiconductor layer based on the photonic integrated circuit pattern after forming the first pattern segments and the second pattern segments.

In a fifth implementation, alone or in combination with one or more of the first through fourth implementations, planarizing the photonic integrated circuit pattern includes planarizing the photonic integrated circuit pattern using a planarization pad that has a modulus that is less than approximately 200 megapascals (MPa).

In a sixth implementation, alone or in combination with one or more of the first through fifth implementations, process 400 includes forming a dielectric waveguide (e.g., an edge coupler waveguide 104) above the sloped section of the first semiconductor waveguide.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

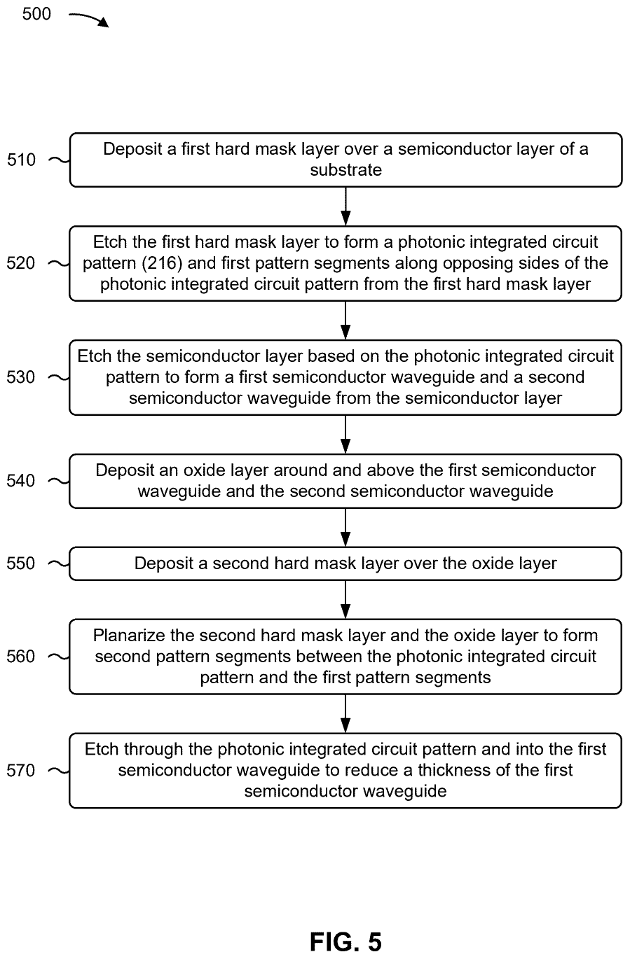

FIG. 5 is a flowchart of an example process 500 associated with forming a photonic integrated circuit described herein. In some implementations, one or more process blocks of FIG. 5 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 5, process 500 may include depositing a first hard mask layer over a semiconductor layer of a substrate (block 510). For example, one or more semiconductor processing tools may be used to deposit a first hard mask layer (e.g., a hard mask layer 212) over a semiconductor layer (e.g., a semiconductor layer 210) of a substrate (e.g., a substrate 204), as described herein.

As further shown in FIG. 5, process 500 may include etching the first hard mask layer to form a photonic integrated circuit pattern and first pattern segments along opposing sides of the photonic integrated circuit pattern from the first hard mask layer (block 520). For example, one or more semiconductor processing tools may be used to etch the first hard mask layer to form a photonic integrated circuit pattern (e.g., a photonic integrated circuit pattern 216) and first pattern segments (e.g., patterned masking segments 214) along opposing sides of the photonic integrated circuit pattern from the first hard mask layer, as described herein.

As further shown in FIG. 5, process 500 may include etching the semiconductor layer based on the photonic integrated circuit pattern to form a first semiconductor waveguide and a second semiconductor waveguide from the semiconductor layer (block 530). For example, one or more semiconductor processing tools may be used to etch the semiconductor layer based on the photonic integrated circuit pattern to form a first semiconductor waveguide (e.g., a coupling waveguide 108) and a second semiconductor waveguide (e.g., a waveguide 106) from the semiconductor layer, as described herein.

As further shown in FIG. 5, process 500 may include depositing an oxide layer around and above the first semiconductor waveguide and the second semiconductor waveguide (block 540). For example, one or more semiconductor processing tools may be used to deposit an oxide layer (e.g., a dielectric layer 220) around and above the first semiconductor waveguide and the second semiconductor waveguide, as described herein.

As further shown in FIG. 5, process 500 may include depositing a second hard mask layer over the oxide layer (block 550). For example, one or more semiconductor processing tools may be used to deposit a second hard mask layer (e.g., a hard masking layer 222) over the oxide layer, as described herein.

As further shown in FIG. 5, process 500 may include planarizing the second hard mask layer and the oxide layer to form second pattern segments between the photonic integrated circuit pattern and the first pattern segments (block 560). For example, one or more semiconductor processing tools may be used to planarize the second hard mask layer and the oxide layer to form second pattern segments (e.g., pattern segments 224) between the photonic integrated circuit pattern and the first pattern segments, as described herein. In some implementations, a portion of the photonic integrated circuit pattern is planarized to form a sloped pattern section (e.g., a sloped pattern section 226) over a portion of the first semiconductor waveguide.

As further shown in FIG. 5, process 500 may include etching through the photonic integrated circuit pattern and into the first semiconductor waveguide to reduce a thickness of the first semiconductor waveguide (block 570). For example, one or more semiconductor processing tools may be used to etch through the photonic integrated circuit pattern and into the first semiconductor waveguide to reduce a thickness of the first semiconductor waveguide, as described herein. In some implementations, the sloped section of the photonic integrated circuit pattern is etched through to form a sloped section (e.g., a sloped section 146) in the first semiconductor waveguide.

Process 500 may include additional implementations, such as any single implementation or any combination of implementations described below and/or in connection with one or more other processes described elsewhere herein.

In a first implementation, a first thickness (e.g., a dimension D1) of a first end of the sloped section of the first semiconductor waveguide is less than a second thickness (e.g., a dimension D2) of a second end of the sloped section of the first semiconductor waveguide after etching through the photonic integrated circuit pattern.

In a second implementation, alone or in combination with the first implementation, a third thickness (e.g., a dimension D4) of the second semiconductor waveguide is greater than the first thickness of the first end of the sloped section of the first semiconductor waveguide and the second thickness of the second end of the sloped section of the first semiconductor waveguide after etching through the photonic integrated circuit pattern.

In a third implementation, alone or in combination with one or more of the first and second implementations, the second end is coupled to the second semiconductor waveguide.

In a fourth implementation, alone or in combination with one or more of the first through third implementations, process 500 includes forming a dielectric waveguide (e.g., an edge coupler waveguide 104) above the first end of the sloped section of the first semiconductor waveguide.

In a fifth implementation, alone or in combination with one or more of the first through fourth implementations, the sloped section of the first semiconductor waveguide has a non-linear slope.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

In this way, a photonic integrated circuit of a semiconductor device includes a coupling waveguide that has a variable thickness between an edge coupler waveguide and a waveguide of another photonic component of the photonic integrated circuit. In particular, a thickness of the coupling waveguide at the first end of the coupling waveguide facing the edge coupler waveguide is less than a thickness of the coupling waveguide at a second end of the coupling waveguide facing the waveguide of the other photonic component. The thickness of the coupling waveguide may transition between the first end and the second end in an approximately linear manner (e.g., the coupling waveguide is tapered between the first end and the second end), in a curved manner (e.g., the coupling waveguide may have a non-linear transition between the first end and the second end), and/or in another manner. The different thicknesses at the first end and the second end of the coupling waveguide enable a low transmission loss to be achieved for coupling of optical signals between the edge coupler waveguide and the coupling waveguide, and between the coupling waveguide and the waveguide of the other photonic component. The gradual transition between the different thicknesses enables a low reflection loss to be achieved between the coupling waveguide and the waveguide of the other photonic component, relative to the transition between the thickness of the coupling waveguide and a thickness of the waveguide of the other photonic component being a stepped transition.

As described in greater detail above, some implementations described herein provide a method. The method includes depositing a hard mask layer over a semiconductor layer of a substrate. The method includes etching the hard mask layer to form a photonic integrated circuit pattern from the hard mask layer. The method includes planarizing the photonic integrated circuit pattern to form a sloped section in a portion of a photonic integrated circuit pattern. The method includes etching the semiconductor layer based on the photonic integrated circuit pattern to form a first semiconductor waveguide and a second semiconductor waveguide from the semiconductor layer, where the sloped section of the photonic integrated circuit pattern is etched through to form a sloped section in the first semiconductor waveguide.

As described in greater detail above, some implementations described herein provide a method. The method includes depositing a first hard mask layer over a semiconductor layer of a substrate. The method includes etching the first hard mask layer to form a photonic integrated circuit pattern and first pattern segments along opposing sides of the photonic integrated circuit pattern from the first hard mask layer. The method includes etching the semiconductor layer based on the photonic integrated circuit pattern to form a first semiconductor waveguide and a second semiconductor waveguide from the semiconductor layer. The method includes depositing an oxide layer around and above the first semiconductor waveguide and the second semiconductor waveguide. The method includes depositing a second hard mask layer over the oxide layer. The method includes planarizing the second hard mask layer and the oxide layer to form second pattern segments between the photonic integrated circuit pattern and the first pattern segments, where a portion of the photonic integrated circuit pattern is planarized to form a sloped pattern section over a portion of the first semiconductor waveguide. The method includes etching through the photonic integrated circuit pattern and into the first semiconductor waveguide to reduce a thickness of the first semiconductor waveguide, where the sloped section of the photonic integrated circuit pattern is etched through to form a sloped section in the first semiconductor waveguide.

As described in greater detail above, some implementations described herein provide a semiconductor device. The semiconductor device includes a first waveguide. The semiconductor device includes a second waveguide physically coupled to a first end of the first waveguide. The semiconductor device includes a third waveguide above a second end of the first waveguide opposing the first end, where a first thickness of the first waveguide at the first end of the first waveguide is greater than a second thickness of the first waveguide at the second end of the first waveguide, and where the second thickness is less than a third thickness of the third waveguide.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
depositing a hard mask layer over a semiconductor layer of a substrate;
etching the hard mask layer to form a photonic integrated circuit pattern from the hard mask layer;
planarizing the photonic integrated circuit pattern to form a sloped section in a portion of a photonic integrated circuit pattern; and
etching the semiconductor layer based on the photonic integrated circuit pattern to form a first semiconductor waveguide and a second semiconductor waveguide from the semiconductor layer,
wherein the sloped section of the photonic integrated circuit pattern is etched through to form a sloped section in the first semiconductor waveguide.

2. The method of claim 1, wherein a first pattern density of oxide material in an area of the semiconductor layer that is to be etched to form a first end of the sloped section in the first semiconductor waveguide is greater than a second pattern density of oxide material in an area of the semiconductor layer that is to be etched to form a second end of the sloped section in the first semiconductor waveguide.

3. The method of claim 2, wherein planarizing the photonic integrated circuit pattern comprises:
planarizing the photonic integrated circuit pattern using a planarization slurry that has a material removal rate for a material of the photonic integrated circuit pattern that is greater than a material removal rate for the oxide material.

4. The method of claim 1, further comprising:
etching the hard mask layer to form first pattern segments along opposing sides of the photonic integrated circuit pattern;
depositing another hard mask layer above the photonic integrated circuit pattern and above the first pattern segments; and
planarizing the other hard mask layer to form second pattern segments between the photonic integrated circuit pattern and the first pattern segments.

5. The method of claim 4, wherein etching the semiconductor layer based on the photonic integrated circuit pattern comprises:
etching the semiconductor layer based on the photonic integrated circuit pattern after forming the first pattern segments and the second pattern segments.

6. The method of claim 1, wherein planarizing the photonic integrated circuit pattern comprises:
planarizing the photonic integrated circuit pattern using a planarization pad that has a modulus that is less than approximately 200 megapascals (MPa).

7. The method of claim 1, further comprising:
forming a dielectric waveguide above the sloped section of the first semiconductor waveguide.

8. A method, comprising:
depositing a first hard mask layer over a semiconductor layer of a substrate;
etching the first hard mask layer to form a photonic integrated circuit pattern and first pattern segments along opposing sides of the photonic integrated circuit pattern from the first hard mask layer;
etching the semiconductor layer based on the photonic integrated circuit pattern to form a first semiconductor waveguide and a second semiconductor waveguide from the semiconductor layer;
depositing an oxide layer around and above the first semiconductor waveguide and the second semiconductor waveguide;
depositing a second hard mask layer over the oxide layer;
planarizing the second hard mask layer and the oxide layer to form second pattern segments between the photonic integrated circuit pattern and the first pattern segments,
wherein a portion of the photonic integrated circuit pattern is planarized to form a sloped pattern section over a portion of the first semiconductor waveguide; and
etching through the photonic integrated circuit pattern and into the first semiconductor waveguide to reduce a thickness of the first semiconductor waveguide,
wherein the sloped section of the photonic integrated circuit pattern is etched through to form a sloped section in the first semiconductor waveguide.

9. The method of claim 8, wherein a first thickness (D1) of a first end of the sloped section of the first semiconductor waveguide is less than a second thickness (D2) of a second end of the sloped section of the first semiconductor waveguide after etching through the photonic integrated circuit pattern.

10. The method of claim 9, wherein a third thickness (D4) of the second semiconductor waveguide is greater than the first thickness of the first end of the sloped section of the first semiconductor waveguide and the second thickness of the second end of the sloped section of the first semiconductor waveguide after etching through the photonic integrated circuit pattern.

11. The method of claim 10, wherein the second end is coupled to the second semiconductor waveguide.

12. The method of claim 9, further comprising:
forming a dielectric waveguide above the first end of the sloped section of the first semiconductor waveguide.

13. The method of claim 8, wherein the sloped section of the first semiconductor waveguide has a non-linear slope.

14. A semiconductor device, comprising:
a first waveguide;
a second waveguide physically coupled to a first end of the first waveguide; and
a third waveguide above a second end of the first waveguide opposing the first end,
wherein a first thickness of the first waveguide at the first end of the first waveguide is greater than a second thickness of the first waveguide at the second end of the first waveguide, and
wherein the second thickness is less than a third thickness of the third waveguide.

15. The semiconductor device of claim 14, wherein the second thickness is less than a third thickness of the third waveguide.

16. The semiconductor device of claim 14, wherein the first waveguide comprises a tapered section between the first end and the second end; and
wherein the tapered section comprises an approximately linear transition between the first thickness and the second thickness.

17. The semiconductor device of claim 16, wherein at least a portion of the tapered section is located under the third waveguide.

18. The semiconductor device of claim 14, wherein the first waveguide comprises a tapered section between the first end and the second end; and
wherein the tapered section comprises a non-linear transition between the first thickness and the second thickness.

19. The semiconductor device of claim 14, wherein the first waveguide comprises a tapered section between the first end and the second end; and
wherein the tapered section comprises a curved transition between the first thickness and the second thickness.

20. The semiconductor device of claim 14, wherein the first waveguide comprises a first semiconductor waveguide;
wherein the second waveguide comprises a second semiconductor waveguide; and
wherein the third waveguide comprises a dielectric waveguide.
